(19) United States
(12) Patent Application Publication
(10) Pub. No.: US 2017/0032529 A1
(43) Pub. Date: Feb. 2, 2017

(54) METHOD OF CALIBRATING A HELMET AND A SYSTEM THEREFOR

(71) Applicant: CSIR, Brummeria (ZA)

(72) Inventors: Jason Peter DE VILLIERS, Amberfield (ZA); Jaco CRONJE, Zwavelpoort (ZA)

(21) Appl. No.: 15/142,334

(22) Filed: Apr. 29, 2016

(30) Foreign Application Priority Data
Jul. 27, 2015 (ZA) SA 2015/05409

(51) Int. Cl. G06T 7/00; B25J 9/16; G01B 11/00

(52) U.S. Cl. CPC G06T 7/0044; G01B 11/002; B25J 9/1697; G06T 2207/30204; G06T 2207/30244

(57) ABSTRACT

A system and method for calibrating a helmet with a plurality of optical markers thereon is provided. The system includes a memory, a camera and a mechanical actuator to which the helmet is connected during the calibration process so that it is movable relative to the camera. A processor is connected to the camera and the mechanical actuator and is programmed to control the mechanical actuator to move the helmet relative to the camera through a plurality of discrete points on a calibration target pattern and at each of the discrete points, control the camera to take a digital image. For each of the images, the processor determines the position of at least one of the plurality of markers in the image and uses the position of the at least one marker in the image together with the position of the mechanical actuator to calibrate the helmet.

### BACKGROUND OF THE INVENTION

The present application relates to a method of calibrating a helmet and a system therefor, particularly a helmet used by a pilot of an aircraft.

In modern combat flight systems the helmet of the pilot is used to control other systems in the aircraft such as the weapons systems simply by the pilot looking in a certain direction. This is generally accomplished by placing of at least one camera in the cockpit and at least one marker on the helmet.

However it will be appreciated that the accuracy of the system is very dependent on proper calibration of the system as every helmet is a slightly different shape and if the marker is placed on the helmet at even a small variance this will have a large impact on the accuracy of the detection of the helmet position and consequently on the accuracy of the systems controlled by the helmet.

The present invention provides an improved method of calibrating a helmet and a system therefor.

### SUMMARY OF THE INVENTION

According to one example embodiment, a system for calibrating a helmet with a plurality of optical markers thereon, the system including:
a memory:
a camera;
a mechanical actuator for moving either the helmet or the camera relative to one another during the calibration process;
a processor connected to the camera and the mechanical actuator; the processor programmed to:
   control the mechanical actuator to move the helmet or the camera relative to one another through a plurality of discrete points on a calibration target pattern;
   at each of the discrete points, control the camera to take a digital image;
   for each of the images, determine the position of at least one of the plurality of optical markers in the image; and
   use the position of the at least one optical marker in the image together with the position of the mechanical actuator to calibrate the helmet.

According to another example embodiment, a method for calibrating a helmet with a plurality of optical markers thereon, the method including:
controlling a mechanical actuator to move the helmet relative or a camera relative to one another through a plurality of discrete points on a calibration target pattern;
at each of the discrete points, controlling the camera to take a digital image;
for each of the images, determining the position of at least one of the plurality of optical markers in the image; and
using the position of the at least one optical marker in the image together with the position of the mechanical actuator to calibrate the helmet.

### BRIEF DESCRIPTION OF THE DRAWINGS

FIG. 1 is an example system for calibrating a helmet; and

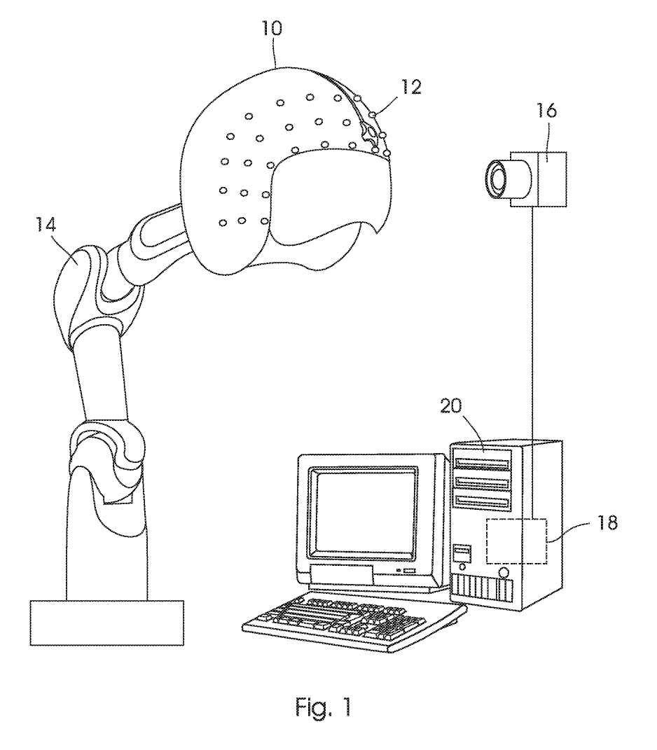

FIG. 2 shows a schematic illustration of a camera for use in the system of the present invention.

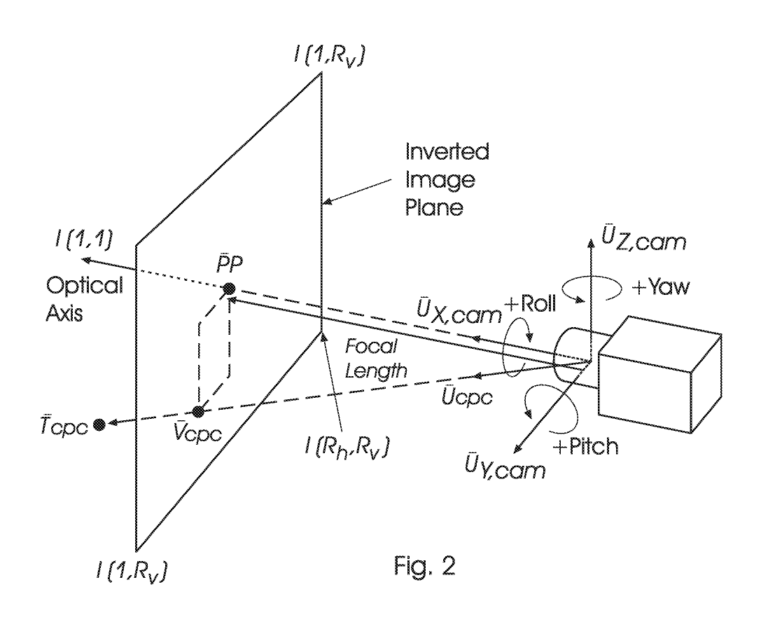

### DESCRIPTION OF EMBODIMENTS

The system and methodology described herein relate to a method of calibrating a helmet and a system therefor.

A helmet 10 that is being calibrated according to the present invention includes a plurality of markers 12 thereon. The calibration system can handle any number of LEDs. Different helmet tracker systems that make use of the calibrations of this system may have requirements on the number of LEDs.

In an example embodiment the plurality of markers 12 are LEDs.

The helmet 10 is connected to a mechanical actuator 14 for the calibration process.

In the illustrated embodiment, he mechanical actuator 14 is a robot arm with six degrees of freedom.

The helmet 10 is connected to the robot arm 14.

In practice each helmet has different mounting points and so a bracket for each helmet is required to attach it to the helmet.

A camera 16 is used to take pictures of the helmet 10 and the markers 12 in a plurality of positions which will be described in more detail below.

The camera 16 is fixed in position for the calibration process with respect to the helmet 10 so that the helmet 10 is moved relative to the camera for the calibration process.

It is possible for the camera to move while the helmet is stationary.

The camera 16 itself needs to be properly calibrated to ensure that there is no distortion in the image taken which would result in incorrect calibration of the target. An example of a calibration methodology for a camera is described in the applicant's published PCT patent application number PCT/IB2012/056820 the contents of which are incorporated herein by reference.

A processor 18, which in the illustrated embodiment forms part of a computer 20 is connected to the camera 10 and the robot arm 14.

The processor 18 is programmed to control the mechanical actuator 14 to move the helmet 10 relative to the camera 16 through a plurality of discrete points on a calibration target pattern.

Ideally for each LED, the viewing angles of the camera should form a cone with a 45 degree angle off axis, and with the apex on the LED. This will mean that the camera vectors are orthogonal and thus provide the greatest noise robustness.

At each of the discrete points the processor 18 controls the camera 16 to take a digital image.

Each digital image is stored in a memory 22 associated with the processor 18 as this digital image is later processed.

At an appropriate time which may be simultaneously or at a later point in time, the processor 18 accesses each of the digital images and determines the position of each of the plurality of markers in the image.

The processor 18 then uses the position of the at least one marker in the image to calibrate the helmet 10.

It will be appreciated that this calibration requires the intrinsic parameters of the observing camera 16 (Distorted-to-undistorted (DU) characterisation and focal length) as well as the absolute pose of the camera with respect to the robot arm 14. This last, in turn, requires the mount pose, and camera offset pose to be known. These are typically direct outputs of an automated photogram metric camera calibration system.

The robot arm 14 is used to simulate a constellation of calibrated cameras at known poses observing each optical reference. Each camera in the constellation uses its intrinsic parameters to determine a vector from it to the optical reference. The closest point of intersection of these vectors is used as the measured position of the optical reference. It is impractical to have a huge constellation of inwardly pointed calibrated cameras rigidly mounted at known positions such that they can triangulate the position of points on all sides of a 3D object placed in the centre of the constellation. To counter this a robot arm is used to present the helmet at different poses to a single calibrated camera whose pose relative to the robot is known.

At each presented pose the camera captures the optical reference (marker 12) centroid and uses the intrinsic parameters to determine a vector to the optical reference. This vector and the camera pose is then calculated relative to the robot arm end using the camera's extrinsic parameters and the reported pose of the robot. This results in a bouquet of vectors and associated known points all expressed in the common coordinate frame of the robot arm end.

In order to calculate the closest point of intersection of the entire vector bouquet, the closest point of each intersection of each possible pair of vectors is calculated and averaged.

Once this average pairwise triangulated position has been determined it is used as a starting point for further numerical refinement. This process is repeated for each marker 12 on the helmet.

The above is accomplished by the processor 18 using a plurality of modules.

In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices.

Referring to the accompanying Figures and describing the methodology in more detail, a vector pointing from the camera to an object in the camera's Field of View (FOV) can be determined if the intrinsic camera parameters (focal length, pixel dimensions, principal point and skewness (assumed to be zero for modern imagers) of the image axes) are known.

Here it is assumed that lens distortion is either negligible or has already been taken into account. The image coordinates are converted to Two Dimensional (2D) spatial values relative to the principle point by using the pixel dimensions. It is important to take into account the different positive direction conventions of the image and camera Coordinate Frame (CF) when doing the scaling (see FIG. 3). In general it is not possible to determine the distance of the object from its position in a single camera's FOV and so the vector is scaled to a Unit Vector (UV). The third dimension is the focal length of the camera. Equation 1 shows how this is done:

$$\begin{matrix}{\overline{U}}_{coc} = {img -> vec}^{} ( {\overline{I}}_{o}^{u} , \overline{PP} , FLen , pix\_w , pix\_h ) \\ = {\overline{V}}_{coc} / ‖ {\overline{V}}_{coc} ‖\end{matrix} \\ where \\ \begin{matrix}{\overline{V}}_{coc} = a vector ending in the inverted image plane pointing from \\ the camera to the object , \\ = [ \begin{matrix}FLen \\ ( {\overline{PP}}_{h} - {\overline{I}}_{{o}_{h}}^{u} ) pix\_w \\ ( {\overline{PP}}_{v} - {\overline{I}}_{{o}_{v}}^{u} ) pix\_h\end{matrix} ] ,\end{matrix} \\ {\overline{U}}_{coc} = a UV pointing from the camera centre to the object , \\ {\overline{I}}_{o}^{u} = {[ {\overline{I}}_{{o}_{h}}^{u} , {\overline{I}}_{{o}_{h}}^{u} ]}^{T} = the undistorted 2 D image pixel position of the object , \\ \overline{PP} = {[ {\overline{PP}}_{h} , {\overline{PP}}_{v} ]}^{T} = the optical axis intersection pixel position , \\ pix\_w = the width of the pixels on the {camera}^{′} s imager , \\ pix\_h = the height of the pixels on the {camera}^{′} s imager , and FLen = the equivalent pinhole model focal length of the {camera}^{′} s lens . \qquad ( 1 )$$

Note that the focal length and pixel dimensions must be specified in the same units.

We now turn to the determination of the closest point of intersection of two three Dimensional (3D) lines. Two 3D lines in free space are unlikely to cross perfectly. Instead they will have a closest point of intersection. In 3D a line is normally defined as a UV which defines the direction of the line, and a 3D point through which the lines passes. At the points along the two lines where they are the closest, the line segment between the two lines will be perpendicular to both lines. Using the identity that the dot product of perpendicular lines is zero, two equations (the zero dot product of the line segment and each line) with two unknowns (the distance to the line segment in each line's UV from the line's known point) can be constructed and then solved simultaneously. Thereafter the average position of the two points on the line closest to each can be taken as the closest point of intersection. Equation 2 provides the mathematics:

$$\begin{matrix}{\overline{T}}_{{rp}_{i} r} = {int}^{} ( {\overline{T}}_{{rp}_{1} r} , {\overline{U}}_{{p}_{1} {V}_{1} r} , {\overline{T}}_{{rp}_{2} r} , {\overline{U}}_{{p}_{2} {v}_{2} r} ) \\ = \frac{1}{2} ( {\overline{T}}_{{rp}_{1} r} + {c}_{1} {\overline{U}}_{{p}_{1} {V}_{1} r} + {\overline{T}}_{{rp}_{2} r} + {c}_{2} {\overline{U}}_{{p}_{2} {V}_{2} r} )\end{matrix} \\ where \\ {\overline{T}}_{{rp}_{i} r} = the position of the closest point of intersection , {c}_{1} = ( {\overline{T}}_{{rp}_{2} r} - {\overline{T}}_{{rp}_{1} r} ) • {\overline{U}}_{{p}_{1} {V}_{1} r} + {c}_{2} ( {\overline{U}}_{{p}_{1} {V}_{1} r} • {\overline{U}}_{{p}_{2} {V}_{2} r} ) , and \\ {c}_{2} = \frac{\begin{matrix}( {\overline{T}}_{{rp}_{2} r} - {\overline{T}}_{{rp}_{1} r} ) • {\overline{U}}_{{p}_{2} {V}_{2} r} - \\ ( {\overline{U}}_{{p}_{1} {V}_{1} r} • {\overline{U}}_{{p}_{2} {V}_{2} r} ) ( {\overline{T}}_{{rp}_{2} r} - {\overline{T}}_{{rp}_{1} r} ) • {\overline{U}}_{{p}_{1} {V}_{1} r}\end{matrix}}{{( {\overline{U}}_{{p}_{1} {V}_{1} r} • {\overline{U}}_{{p}_{2} {V}_{2} r} )}^{2} - 1} , \\ {\overline{T}}_{{rp}_{1} r} = a point on line 1 , {\overline{U}}_{{p}_{1} {V}_{1} r} = unit direction vector of line 1 , {\overline{T}}_{{rp}_{2} r} = a point on line 2 , \\ {\overline{U}}_{{p}_{1} {V}_{2} r} = unit direction vector of line 2. \qquad ( 2 )$$

When applying Brown's distortion model it can be shown that using sufficient parameters in Brown's distortion model, the lens distortion effects in both the Distorted to Undistorted (DU) direction as well as the Undistorted to Distorted (UD) direction can be effectively modelled. Separate parameter sets are required for each direction.

Determining the DU and UD parameters may be performed by any suitable photogrammetric calibration suite.

The basic Brown model takes the input pixel coordinate and expresses it relative to the principal point. Thereafter the distance of the input point from the principal point is used to add both radial and tangential offsets to create the output pixel position.

The radial and tangential offsets are in the form of polynomials dependant on the distance of the input point from the principal point. It is the coordinates of the principal point, and the coefficients of the radial and tangential polynomials which constitute the distortion parameters. The mathematics is shown in Equation 3:

$$\begin{matrix}{\overline{P}}_{h , v}^{*} = {Brown}^{} ( {\overline{P}}_{h , v}^{*} , {\overline{P}}_{h , v}^{C} , {R}_{1} … {R}_{{N}_{R}} , {T}_{1} … {T}_{{N}_{T}} ) , \\ = {Brown}^{} ( {\overline{P}}_{h , v}^{*} , {\overline{V}}_{params} )\end{matrix} \\ where \\ {Brown}^{} = {Brown}^{′} s distrotion model [ 4 , 5 ] , \\ {\overline{V}}_{params} = {[ {\overline{P}}_{h}^{C} {\overline{P}}_{v}^{C} , {K}_{1} … {K}_{{N}_{R}} , {P}_{1} … {P}_{{N}_{T}} ]}^{T} , \\ {\overline{P}}_{h}^{*} = {\overline{P}}_{h} + ( {\overline{P}}_{h} - {\overline{P}}_{h}^{C} ) ( {\sum }_{i = 1}^{{N}_{R}} {R}_{i} {r}^{2 i} ) + ( ( 1 + {\sum }_{i = 3}^{{N}_{T}} {T}_{i} {r}^{2 i - 4} ) \times ( {T}_{1} ( {r}^{2} + 2 {( {\overline{P}}_{h} - {\overline{P}}_{h}^{C} )}^{2} ) + 2 {T}_{2} ( {\overline{P}}_{h} - {\overline{P}}_{h}^{C} ) ( {\overline{P}}_{v} - {\overline{P}}_{h}^{C} ) ) ) , \\ {\overline{P}}_{v}^{*} = {\overline{P}}_{v} + ( {\overline{P}}_{v} - {\overline{P}}_{v}^{C} ) ( {\sum }_{i = 1}^{{N}_{R}} {R}_{i} {r}^{2 i} ) + ( ( 1 + {\sum }_{i = 3}^{{N}_{T}} {T}_{i} {r}^{2 i - 4} ) \times ( 2 {T}_{1} ( {\overline{P}}_{h} - {\overline{P}}_{h}^{C} ) ( {\overline{P}}_{v} - {\overline{P}}_{v}^{C} ) + {T}_{2} ( {r}^{2} + 2 {( {\overline{P}}_{v} - {\overline{P}}_{h}^{C} )}^{2} ) ) ) , \\ {\overline{P}}_{h , v}^{*} = output image point , {\overline{P}}_{h , v} = input image point , \\ {\overline{P}}_{h , v}^{C} = centre of distortion , {R}_{n} = {N}^{th} radial distortion coefficient , \\ {T}_{n} = {N}^{th} tangential distortion coefficient , \\ {N}_{R} = number of radial parameters , {N}_{T} = number of tangential parameters , and r = \sqrt{{( {h}_{d} - {h}_{c} )}^{2} + {( {v}_{d} - {v}_{c} )}^{2}} . \qquad ( 3 )$$

Note that it is not possible to use one tangential parameter, either zero, or two or more tangential parameters are required. Whether Equation 3 distorts or undistorts an image point is dependent on what parameters are passed to it.

Throughout the rest of this description passing parameters to Equation 3 called DUparams will mean that the point will be converted from the distorted domain to the undistorted domain.

Similarly, the parameter vector UDparams will be used to convert undistorted pixels coordinates to their corresponding coordinates in the distorted domain.

How the spatial positions of the Light Emitting Diode (LED)s on the helmet are determined is now described.

This calibration requires the intrinsic parameters of the observing camera (DU characterisation and focal length) as well as the absolute pose of the camera with respect to (w.r.t.) the robot. This last, in turn, requires the mount pose, and camera offset pose to be known.

The robot arm is used to simulate a constellation of calibrated cameras at known poses observing each LED. Each camera in the constellation uses its intrinsic parameters to determine a vector from it to the LED. The closest point of intersection of these vectors is used as the measured position of the LED. It is impractical to have a huge constellation of inwardly pointed calibrated cameras rigidly mounted at known positions such that they can triangulate the position of points on all sides of a 3D object placed in the center of the constellation.

To simulate this scenario, a robot arm is used to present the helmet at different poses to a single calibrated camera whose pose relative to the robot is known. For each pose at which the helmet is presented, the pose of the calibrated camera relative to the helmet is calculated, this effectively adding another camera to a virtual constellation of cameras all looking inward at the helmet.

At each presented pose the camera captures an image of the LED/s and determines the coordinate of each LED/s in the image. The exact method of determining the LED image coordinate can be altered, the example embodiment uses the methods described in the applicant's prior published patent application no PCT/IB2012/056820.

The corresponding vector associated with the image coordinate is then calculated from the calibration parameters of the camera. This vector and the camera pose is then transformed to the robot arm's CF using the known pose of the camera with respect to the robot base CF and the pose of the robot's arm w.r.t. the robot base CF.

This results in a bouquet of vectors and associated known points all expressed in the common CF of the robot arm's.

In order to calculate the closest point of intersection of the entire vector bouquet, an initial estimate of the closest point of each intersection of the entire bouquet is determined and then numerically refined. The initial estimate is calculated by averaging the closest point of intersection of each possible pair of vectors. This initial estimation is expressed mathematically in Equation 4:

$${\overline{T}}_{ala}^{*} = \frac{2}{{N}^{2} - N} {\sum }_{i = 0}^{N - 2} {\sum }_{j = i + 1}^{N} ( {\overline{T}}_{{al}_{i , j} a} ) \\ where \\ {\overline{T}}_{ala}^{*} = initial LED position w . r . t . robot arm , \\ N = the number of views of the LED , \\ \begin{matrix}{\overline{T}}_{{al}_{i , j} a} = position of LED w . r . t . arm triangulated from positions \\ i and j , \\ = {int}^{} ( {\overline{T}}_{a {c}_{i} a} , {\overline{U}}_{{c}_{i} la} , {\overline{T}}_{a {c}_{j} a} , {\overline{U}}_{{c}_{j} la} ) ,\end{matrix} \\ \begin{matrix}{\overline{T}}_{a {c}_{n} a} = translation of camera relative to end effector at position n , \\ = {R}_{{a}_{n} r}^{T} ( {\overline{T}}_{rcr} - {\overline{T}}_{{ra}_{n} r} ) ,\end{matrix} \\ \begin{matrix}{\overline{U}}_{{c}_{n} la} = UV from camera to LED with arm at position n , \\ = {R}_{{a}_{n} r}^{T} {R}_{cr} ( {img -> vec}^{} ( {Brown}^{} ( {\overline{I}}_{n}^{d} , {\overline{DU}}_{params} ) , {\overline{I}}_{params} ) ) ,\end{matrix} \\ {int}^{} = as per Equation ( 2 ) , \\ {img -> vec}^{} = as per Equation ( 1 ) , \\ {Brown}^{} = {Brown}^{′} s distortion model [ 4 , 5 ] , \\ {\overline{DU}}_{params} = distortion corrections parameters , as per ( e . g ) [ 3 ] , {\overline{I}}_{params} = intrinsic camera paramters s per ( e . g . ) [ 3 ] , \\ {\overline{I}}_{i}^{d} = LED pixel position for robot pose i , \\ {R}_{cr} , {\overline{T}}_{rcr} = pose of the camera relative to the robot in robot axis , \\ and \\ {R}_{{a}_{n} r} , {\overline{T}}_{{ra}_{n} r} = pose of the arm at position n w . r . t . the robot in robot axis . \qquad ( 4 )$$

Once the initial estimate is determined using Equation 4 it is used as a starting point for further numerical refinement.

The refinement seeks to find the point with the smallest Root Mean Square (RMS) sum of perpendicular distances from each vector in the bouquet. In the example embodiment the Leapfrog algorithm is used. Equation 4 provides the mathematical derivation of the RMS sum of perpendicular distances cost function.

$${C}^{HLED} ( {\overline{T}}_{ala}^{H} ) = \sqrt{\frac{1}{N} {\sum }_{i = 0}^{N - 1} ( {‖ {\overline{T}}_{ala}^{H} - {\overline{T}}_{a {c}_{i} a} ‖}^{2} - {( ( {\overline{T}}_{ala}^{H} - {\overline{T}}_{a {c}_{i} a} ) • {\overline{U}}_{{c}_{i} {lc}_{i}} )}^{2} )} \\ where \\ {C}^{HLED} = the cost function to determine a helmet {LED}^{′} s translation \\ {\overline{T}}_{ala}^{H} = hypothesised position of the LED w . r . t . arm , \\ N = the number of views of the LED , \\ \begin{matrix}{\overline{T}}_{a {c}_{i} a} = position of camera w . r . t arm for arm position i , \\ = {R}_{{a}_{i} r}^{T} ( {\overline{T}}_{rcr} - {\overline{T}}_{{ra}_{i} r} ) ,\end{matrix} \\ \begin{matrix}{\overline{U}}_{{c}_{i} {lc}_{i}} = UV from camera to LED for robot pose i , \\ = {R}_{{a}_{i} r}^{T} {R}_{cr} = ( {img -> vec}^{} ( {Brown}^{} ( {\overline{I}}_{i}^{d} , {\overline{DU}}_{params} ) , {\overline{I}}_{params} ) ) ,\end{matrix} \\ {img -> vec}^{} = as per Equation ( 1 ) , \\ {Brown}^{} = {Brown}^{′} s distortion model [ 4 , 5 ] , \\ {\overline{DU}}_{params} = distortion corrections parameters as per ( e . g . ) [ 3 ] , {\overline{I}}_{params} = intrinsic camera parameters s per ( e . g . ) [ 3 ] , {\overline{I}}_{i}^{d} = LED pixel position for robot pose i , \\ {R}_{cr} , {\overline{T}}_{rcr} = known pose of the camera w . r . t . the robot , and \\ {R}_{{a}_{i} r} , {\overline{T}}_{{ra}_{i} r} = reported pose of end \text{-} effect w . r . t . robot axis . \qquad ( 5 )$$

The above process is repeated for each LED on the helmet.

The capture of all the required centroids on the helmet is typically performed via one large movement sequence.

Now it is shown how the positions of the LEDs can be expressed in a different CF. This may be required due to it not being possible to mount the helmet on the robot arm such that the intended helmet and robot end effector CFs coincide or are even aligned. In addition the mounting of the helmet to the robot arm may be non-repeatable (although it is required to be rigid for this calibration to work).

This calibration requires a reference set of LED positions to which the measured set of LED positions must match as closely as possible. Typically this reference position will be the theoretical design positions that would have been obtained with perfect manufacturing techniques.

This calibration determines the pose offset that, when applied to each of the measured LED positions, causes them to most closely match the reference LED positions.

The match closeness is quantified as the RMS of distances between the measured LED positions (after having the pose offset applied) and the reference LED positions.

The pose which produces the minimum RMS distance error is determined via numerical optimisation. Once again the Leapfrog algorithm is used in the example embodiment with the initial position being determined by the bracket used to mate the helmet to the robot end effector.

The cost function, which determines the RMS distance error, is given by Equation 6:

$${C}^{M -> T} ( {R}_{ah}^{H} , {\overline{T}}_{ahh}^{H} ) = \sqrt{\frac{1}{N} {\sum }_{i = 0}^{N - 1} {‖ {\overline{T}}_{{hl}_{i} h} - {\overline{T}}_{{hl}_{i} h}^{H} ‖}^{2}} \\ where \\ \begin{matrix}{C}^{M -> T} = the measured to theoretical LED translation \\ correction cost function ,\end{matrix} \\ \begin{matrix}{R}_{ah}^{H} , {\overline{T}}_{ahh}^{H} = hypothesised pose to align the measured \\ and theoretical LED point clouds ,\end{matrix} \\ {\overline{T}}_{{hl}_{i} h} = the theoretical position LED i , \\ \begin{matrix}{\overline{T}}_{{hl}_{i} h} = the realigned measured position of LED i , \\ = {R}^{H} ah {\overline{T}}_{{al}_{i} a} + {\overline{T}}_{ahh}^{H} , and\end{matrix} \\ \begin{matrix}{\overline{T}}_{{al}_{i} a} = the measured position of helmet LED i w . r . t . \\ robot arm .\end{matrix} \qquad ( 6 )$$

The above is implemented practically using the following method steps.

Data Capture Capture Phase:

For each entry in the list of robot poses:
1) Move the robot to the specified pose,
2) Capture and store to memory the exact pose achieved by the robot arm.
3) Capture and store to memory an image of the optical reference/s for that pose.

Helmet Calibration Phase:
1) Retrieve from the memory the intrinsic camera parameters including the focal length, pixel dimensions, principal point and skewness and lens distortion correction parameters.
2) Retrieve from memory the pose of the camera relative to the robot arm.
3) For each optical reference on the helmet:
   3.1) For each image captured of that optical reference:
   3.1.1) Retrieve the image from the memory.
   3.1.2) Determine the pixel coordinates of the optical reference in the image.
   3.1.3) Convert the image co-ordinates to a 3D vector in the camera's CF using the retrieved camera intrinsic parameters.
   3.1.4) Retrieve from memory the achieved pose of the robot arm for this picture.
   3.1.5) Calculate the pose of the camera relative to the end of the robot arm using the retrieved arm robot arm pose and the retrieved camera pose.
   3.1.6) Calculate the projection of the 3D vector in the coordinate frame of the robot arm end.
   3.1.7) Determine the approximate closest point of intersection of all the 3D vectors for this optical reference.
   3.1.8) Numerically refine this closest point of intersection.
   3.1.9) Store this point as the measured position of the optical reference.
   3.2) Save the set of measured optical reference positions to memory.

Helmet Alignment Phase:
1) Retrieve from memory a reference ideal set of optical reference positions.
2) Retrieve from memory the set of measured optical reference positions.
3) Determine the sum of displacements between corresponding optical references.
4) Find the pose that when applied to the measured optical reference positions minimises the sum of displacements.
5) Apply the determined pose to the measured optical reference positions to generate the set of aligned optical reference positions,
6) Save to memory the aligned optical reference positions.

The system can also be used to verify the accuracy of a helmet tracker system, i.e. the calibration of the cameras, the aircraft, and helmet. This is done by mounting the robot arm in the operational aircraft and presenting the calibrated helmet at known positions to the collection of calibrated cameras. The differences between the optically determined measurements and the known poses are then calculated. If desired this information can be used to further refine either the cameras, helmet or aircraft calibration to improve the installed operational accuracy of the specific helmet tracker being installed.

Thus it will be appreciated that the optical helmet tracker calibration system fulfils a need for manufacturers and end users of helmet tracking technology to ensure optimal performance of their systems. This can take the form of both initial calibrations, calibrations due to events such as hard landings, and periodic re-calibrations as may be called for in logistic support plans.

1. A system for calibrating a helmet with a plurality of optical markers thereon, the system including:
a memory;
a camera;
a mechanical actuator for moving either the helmet or the camera relative to one another during the calibration process;
a processor connected to the camera and the mechanical actuator;
the processor programmed to:
control the mechanical actuator to move the helmet or the camera relative to one another through a plurality of discrete points on a calibration target pattern;
at each of the discrete points, control the camera to take a digital image;
for each of the images, determine the position of at least one of the plurality of optical markers in the image; and
use the position of the at least one optical marker in the image together with the position of the mechanical actuator to calibrate the helmet.

2. A system according to claim 1 wherein the processor determines the position of at least one of the plurality of markers by:
determining pixel coordinates of the optical marker in the image;
converting the image co-ordinates to a 3D vector in a camera coordinate frame using camera intrinsic parameters retrieved from the memory;
retrieving from the memory a pose of the robot arm for the image;
calculating a pose of the camera relative to the end of the robot arm using the retrieved arm robot arm pose and the retrieved camera pose;
calculating a projection of the 3D vector in a coordinate frame of the robot arm end;
determining an approximate closest point of intersection of all the 3D vectors for this optical reference; and
numerically refining this closest point of intersection as the measured position of the optical marker.

3. A system according to claim 2 wherein the determined position of each of the optical markers are stored in the memory.

4. A system according to claim 1 wherein the processor uses the determined position of the at least one optical marker in the image together with the position of the mechanical actuator to calibrate the helmet by:
retrieving from the memory a reference ideal set of optical marker reference positions;
retrieving from the memory the set of determined optical marker reference positions;
calculating a sum of displacements between corresponding optical references;
determining a pose that when applied to the measured optical reference positions minimises the sum of displacements; and
applying the determined pose to the measured optical reference positions to generate a set of aligned optical reference positions.

5. A system according to claim 4 wherein the set of aligned optical reference positions are stored in the memory.

6. A method for calibrating a helmet with a plurality of optical markers thereon, the method including:
controlling a mechanical actuator to move the helmet relative or a camera relative to one another through a plurality of discrete points on a calibration target pattern;
at each of the discrete points, controlling the camera to take a digital image;
for each of the images, determining the position of at least one of the plurality of optical markers in the image; and
using the position of the at least one optical marker in the image together with the position of the mechanical actuator to calibrate the helmet.

7. A method according to claim 6 wherein the position of at least one of the plurality of optical markers is determined by:
determining pixel coordinates of the optical markers in the image;
converting the image co-ordinates to a 3D vector in a camera coordinate frame using camera intrinsic parameters retrieved from the memory;
retrieving from the memory a pose of the robot arm for the image;
calculating a pose of the camera relative to an end of the robot arm using the retrieved arm robot arm pose and the retrieved camera pose;
calculating a projection of the 3D vector in a coordinate frame of the robot arm end;
determining an approximate closest point of intersection of all the 3D vectors for this optical marker;
numerically refining this closest point of intersection as the measured position of the optical marker.

8. A method according to claim 7 wherein the determined position of the at least one optical marker is stored in a memory.

9. A method according to claim 8 wherein the determined position of the at least one optical marker in the image is used together with the position of the mechanical actuator to calibrate the helmet by:
retrieving from the memory a reference ideal set of optical reference positions;
retrieving from the memory the set of determined optical marker reference positions;
calculating a sum of displacements between corresponding optical marker references;
determining a pose that when applied to the measured optical reference positions minimises the sum of displacements; and
applying the determined pose to the measured optical reference positions to generate a set of aligned optical reference positions.

10. A method according to claim 9 wherein the set of aligned optical reference positions are stored in the memory.
